(19) United States
(12) Patent Application Publication
(10) Pub. No.: US 2017/0050129 A1
(43) Pub. Date: Feb. 23, 2017

(54) FLOATING SUCTION HEAD ASSEMBLY

(71) Applicant: Kochek Co., Inc., Putnam, CT (US)

(72) Inventor: Gregory Kozey, Eastford, CT (US)

(73) Assignee: Kochek Co., Inc., Putnam, CT (US)

(21) Appl. No.: 15/240,351

(22) Filed: Aug. 18, 2016

Related U.S. Application Data
(60) Provisional application No. 62/206,536, filed on Aug. 18, 2015.

(51) Int. Cl. B01D 35/05; B01D 35/153; E03B 3/04; B01D 33/073

(52) U.S. Cl. CPC B01D 35/05; B01D 33/073; B01D 35/153; E03B 3/04

(57) ABSTRACT

A floating suction head assembly for use with a hose, for drawing liquid into the hose. The assembly includes a float assembly, a gusset member coupled to the float assembly and a strainer assembly rotatably mounted to the gusset member. The strainer assembly has a coupling portion for coupling to a hose. The strainer assembly is rotatable relative to the gusset member and the float assembly about a central longitudinal axis defined by the strainer assembly. The strainer assembly includes a strainer cage defining an interior cavity, and a strainer cartridge selectively disposable in the interior cavity and retained therein. The strainer cartridge has a generally cylindrical configuration and rotates about the central longitudinal axis of the strainer assembly. The strainer cartridge includes a corrugated exterior surface including bent portions forming alternating furrow and ridge portions substantially about the circumference of the strainer cartridge.

### CROSS REFERENCE

This application claims the benefit of U.S. Provisional Patent Application No. 62/206,536 filed on Aug. 18, 2015, the contents of which are incorporated herein by reference in their entirety. This application relates to and claims an improvement to the floating suction head assembly disclosed in commonly owned U.S. Pat. No. 7,794,589 to Kozey issued on Sep. 14, 2010, the contents of which are incorporated herein by reference in their entirety.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the United States Patent and Trademark Office files or records, but otherwise reserves all copyright rights whatsoever.

### BACKGROUND

Technical Field

This invention relates to floating suction head assemblies of the type employed for drawing liquid, namely, water, from areas including an open body of water such as a pond, lake, stream, river, and the like.

Related Art

It is sometimes necessary to pump water from an open body of water such as a pond, a lake, a stream, etc., for purposes of firefighting, irrigation, etc., by drawing or drafting the water into a suction pump through a hose that has an intake end in the body of water. Such bodies of water often contain debris, such as leaves, twigs, fish, etc., that interfere with the operation of the pump (e.g., obstructs a partial vacuum created by the pump to force water into the hose) or that are simply not wanted within the water being pumped. It is known to provide a strainer on the intake end of the hose to prevent debris from entering the hose. To reduce the introduction of silt, fish or other life in the water, or other unwanted matter from the water or bottom of the body of water, into the stream of water being drawn the intake end of the hose can be attached to a suction head assembly that includes the strainer and a float to keep the intake end of the hose near the water surface. However, it is necessary to avoid drawing air into the hose, since air reduces the efficiency of the pumping operation and, depending on the pump, may cause the pump to lose its prime/partial vacuum and thereby become inoperable.

U.S. Pat. No. 4,647,374 to Michael P. Ziaylek et al. discloses a suction head assembly of the type mentioned. The suction head assembly comprises a pan secured onto a hose. The pan has an open mesh wire screen and is securable to a float.

Commonly owned, U.S. Pat. No. 4,973,405 to Kozey discloses a floating suction head assembly for connection with fire hoses and the like. The assembly comprises a U-shaped float of hollow tubular construction. A tubular strainer is disposed between the arms of the float and has small openings along the bottom and side portions of the strainer for admitting water, but to avoid drawing air into the strainer, there are no openings on the top of the strainer. The strainer is pivotably connected to the float for pivoting motion about an axis that is perpendicular to the central axis of the strainer.

Commonly owned, U.S. Pat. No. 7,794,589 to Kozey discloses a floating suction head assembly comprising a float and a strainer rotatably coupled at a first end to the float. The strainer extends outwardly in a longitudinal direction from the first end and is cantilevered relative thereto. The strainer is rotatable relative to the float about an axis defined by the strainer. A coupling portion is mounted on an end of the strainer. The coupling portion defines a bore extending therethrough. The coupling portion is adapted to matingly engage another coupling portion attached to an end of a hose.

### SUMMARY

The present invention resides in one aspect in an improvement to commonly owned, floating suction head assemblies for use with a hose for drawing liquid into the hose. The improved suction head assembly comprises a float assembly and a strainer assembly mounted to the float assembly. A hose is attached to the strainer assembly, and the suction head assembly is placed in a body of water in which the suction head assembly floats. The strainer assembly strains water drawn into the hose, and the float assembly allows the strainer assembly to remain under the surface of the water, but keeps the strainer assembly from sinking to the bottom of the body of water. The strainer assembly is secured to the float assembly by a rotatable coupling portion to accommodate rotation of a hose relative to the float assembly and thus relieve torque received via the hose. Such torque may be generated in a floating suction head assembly that lacks a rotatable coupling for the hose. In one aspect of the present invention, the strainer assembly includes a strainer cage defining an interior cavity receiving and retaining a removable strainer cartridge therein. The strainer cartridge has a generally cylindrical configuration to facilitate rotation about a central axis of the strainer assembly. The strainer cartridge includes a corrugated exterior surface including bent portions forming alternating furrow and ridge portions substantially about the circumference of the strainer cartridge. In one embodiment, the strainer cartridge is formed of wire mesh material or perforated sheet material having a plurality of solid surface portions and perforated portions or perforations about the circumference of the strainer cartridge.

### BRIEF DESCRIPTION OF THE DRAWINGS

FIG. 1 is a schematic elevation view of a conventional floating suction head assembly in a body of liquid such as water;

FIG. 2 is a partial view of the floating suction head assembly of FIG. 1, showing the bearing in an enlarged, partly sectional view;

FIG. 3 is a schematic elevation view of another embodiment of a conventional floating suction head assembly;

FIG. 4 is an end view of the assembly of FIG. 1;

FIG. 5 is a side view of another conventional floating suction head assembly;

FIG. 6 is a schematic perspective view of a conventional floating suction head assembly;

FIG. 7 is a side elevation view of the assembly of FIG. 6 illustrating one float in phantom to reveal a handle;

FIG. 8 is a front end elevation view of the assembly of FIG. 6;

FIG. 9 is a back end elevation view of the assembly of FIG. 6;

FIG. 10 is a schematic elevation view of a conventional floating suction head assembly including a check valve;

FIG. 11 is an end view of the assembly of FIG. 10, showing the check valve therein;

FIG. 12 is a schematic cross-sectional view of a conventional strainer with a poppet-type check valve;

FIG. 13 is a schematic elevation view of a floating suction head assembly, in accordance with one embodiment of the present invention;

FIG. 14 is a side, perspective view of the floating suction head assembly of FIG. 13;

FIG. 15 is an end view of the assembly of FIG. 13;

FIG. 16 is a side, perspective exploded assembly view of the floating suction head assembly of FIG. 13;

FIG. 17 is a side, perspective exploded assembly view of a strainer cage in accordance with one embodiment of the floating suction head assembly of FIG. 13;

FIG. 18 is an elevation view of a strainer cartridge in accordance with one embodiment of the invention; and

FIGS. Detail 18A to 18D are enlarged, views of a portion of the strainer cartridge in accordance with various embodiments.

### DESCRIPTION OF PREFERRED EMBODIMENTS

This invention provides a floating suction head assembly for attachment to a hose for use in drawing a liquid, such as water, from a body of liquid in a pumping operation, for firefighting purposes, irrigation purposes, and the like. The assembly comprises a float assembly and a strainer assembly mounted to the float assembly. A hose is attached to the strainer assembly, and the suction head assembly is placed in a body of water in which the suction head assembly floats. The strainer assembly strains water drawn into the hose, and the float assembly allows the strainer assembly to remain under the surface of the water, but keeps the strainer assembly from sinking to the bottom of the body of water. The strainer assembly is secured to the float assembly by a rotatable coupling portion (such as a bearing) to accommodate rotation of a hose relative to the float assembly and thus relieve torque received via the hose. Such torque may be generated in a floating suction head assembly that lacks a rotatable coupling for the hose, if the assembly is placed in the water upside-down, in which case the stiffness of the hose can prevent the assembly from righting itself. In one aspect of the present invention, the strainer assembly includes a strainer cage defining an interior cavity receiving and retaining a removable strainer cartridge therein. The strainer cartridge is removable for cleaning or other maintenance, or replacement. The strainer cartridge has a generally cylindrical configuration to facilitate rotation about a central axis of the strainer assembly. In one embodiment, the strainer cartridge includes a corrugated exterior surface including bent portions forming alternating furrow and ridge portions substantially about the circumference of the strainer cartridge. In one embodiment, the strainer cartridge is formed of wire mesh material or perforated sheet material having a plurality of solid surface portions and perforated portions or perforations about the circumference of the strainer cartridge.

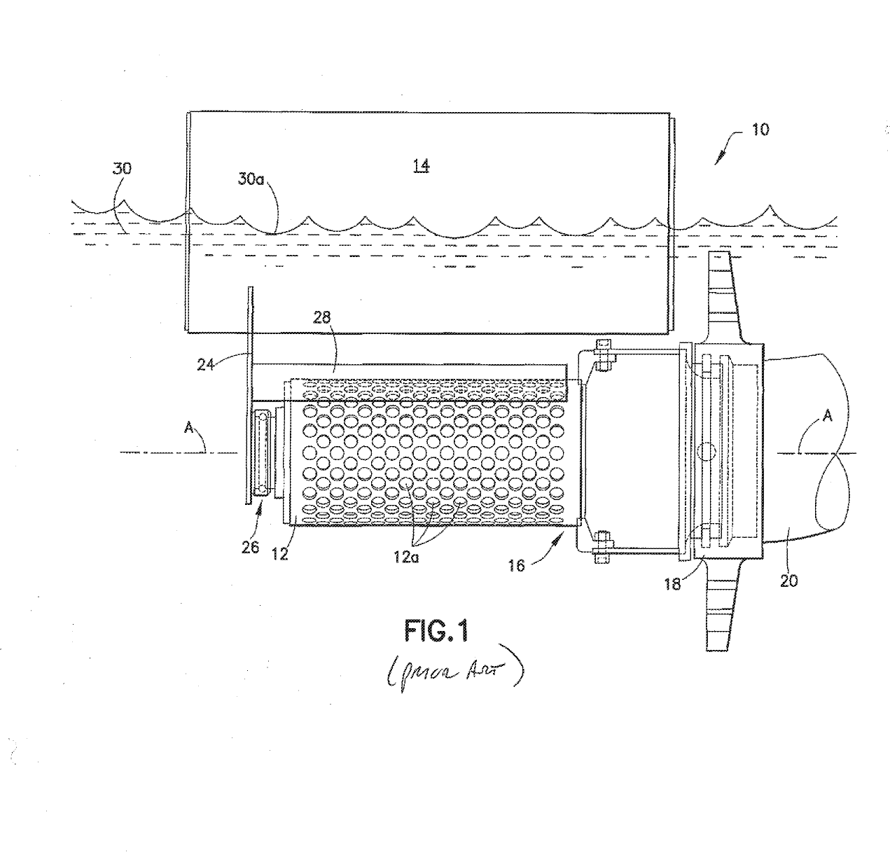

As shown in FIG. 1 and described in U.S. Pat. No. 7,794,589 to Kozey, a commonly owned, prior art floating suction head assembly, generally designated by reference numeral 10, comprises a strainer 12 secured to a float 14. The float 14 is a buoyant body, for example, a hollow, rigid metal or plastic chamber, a solid buoyant material, or a pliable, inflatable floatation sac, or the like. In contrast, the strainer 12 is a non-buoyant body. The float 14 is sufficiently buoyant that it floats even with the strainer 12 attached thereto and with a length of hose secured to the floating suction head assembly 10 (hereinafter referred to also as “head assembly 10”). The strainer 12 has a coupling portion 16 for receiving a hose 20. The coupling portion 16 may include a coupler 18 for joining a hose to the strainer 12. The coupler 18 optionally may be any standard hose coupler such as a Storz coupler, a NST coupler, a barb shank, etc., for a standard fire hose, a garden hose, and the like, of various diameters to accommodate an intended operation of the head assembly 10 and capacity (e.g., gallons per minute) of water intended to be drawn from the body of water in the pumping operation. As shown in FIG. 1, the strainer 12 has a central, longitudinal axis A extending centrally through the strainer 12 and through the coupling portion 16. The strainer 12 has a generally cylindrical configuration and a plurality of perforations 12a around the entire circumference of the strainer.

A gusset member 24 extends downwardly from the float 14 to provide a mounting point for the strainer. Optionally, the strainer 12 is mounted on the gusset member 24 at a point on the central axis A opposite from the coupling portion 16, as shown in FIG. 1. The gusset member 24 is made from a substantially rigid, non-buoyant material.

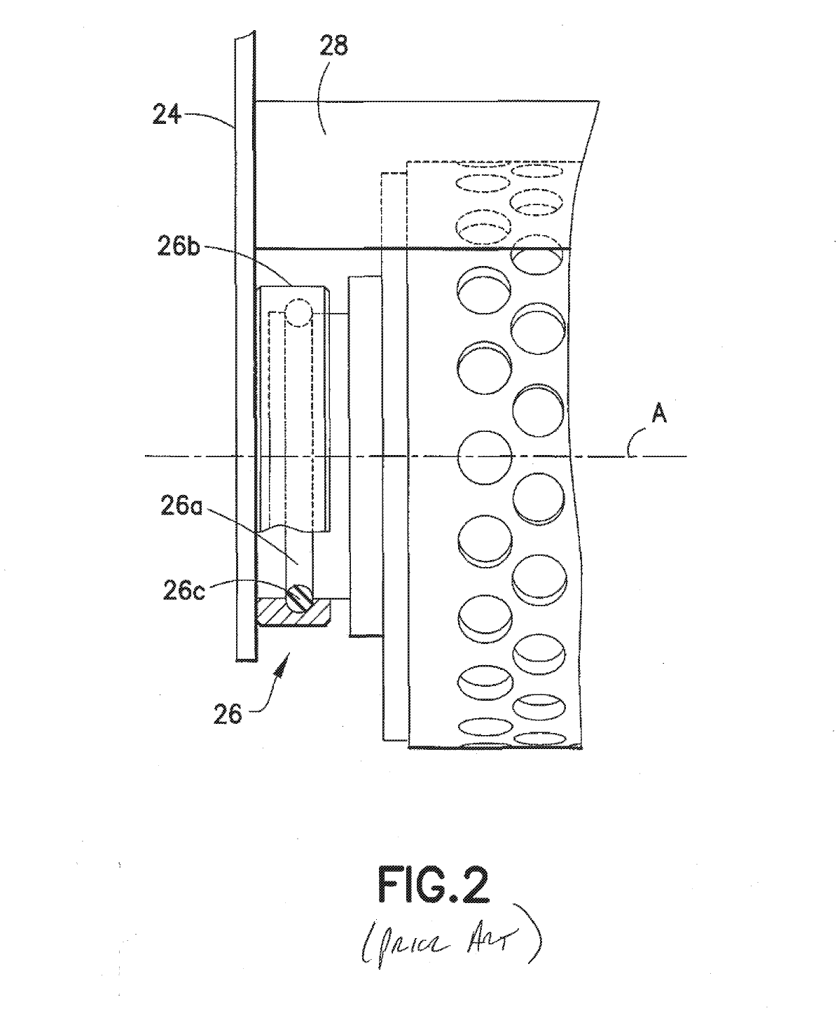

The strainer 12 is mounted to the gusset member 24 via a rotatable coupling comprising a bearing 26, illustrated in an enlarged, detail view of FIG. 2. The bearing 26 comprises an inner race 26a and an outer race 26b that together define a raceway for a plurality of rolling elements 26c disposed between the inner race and the outer race. The outer race 26b is mounted on the gusset member 24 and the inner race 26a is coupled to or formed on the end of the strainer 12 opposite from the coupling portion 16. The bearing 26 permits the strainer 12 to rotate relative to the gusset member 24 and to the float 14 in response to torque received via a hose connected to the strainer. The bearing 26 is situated to permit the strainer 12 to rotate about the central axis A. While FIG. 2 shows the outer race 26b secured onto the gusset member 24 and the inner race formed on the strainer 12, this is not a limitation, and in other embodiments, the outer race is formed on the strainer and the inner race is on the gusset member. In still other embodiments, other rotatable couplings may be used instead of a bearing 26, such as a mounting pin, journal, bushing, etc.

As shown in FIGS. 1, 3 and 4, the head assembly 10 is floating in a body of water 30. The float 14 rests at or near a top surface 30a of the water such that the gusset member 24 extends downward from the float, and the strainer 12 on the gusset member 24 below the float 14 is fully immersed in the water 30. In this way, the chance that strainer 12 is exposed to air above the surface 30a and draws air into the hose 20 (e.g., minimizing the efficiency and effectiveness, or substantially eliminating the partial vacuum) is reduced. As can be appreciated by those skilled in the art, drawing air into the hose 20 would interfere with a pumping operation because sufficient air can destroy the prime/vacuum of the pump and may cause surging and/or cavitation. The head assembly 10, by keeping the strainer 12 below the water surface, makes it feasible to dispose perforations around the entire circumference of the strainer, so that water can be drawn from around the entire circumference of the strainer. It is therefore possible to draw water through the strainer 12 at a greater rate than through a similarly configured strainer that has perforations only along part of the circumference. On the other hand, the gusset member 24 is preferably configured so that the strainer 12 is not too far below the water surface 30a. In this way, the assembly 10 can reduce the tendency to draw sand, mud and/or debris from the bottom of the body of water 30.

At high rates of water movement or flow into the strainer 12 during a pumping operation, there is a possibility of forming a vortex in the water 30 that funnels down from the surface 30a to the strainer 12. Should such a vortex form, air might be drawn into the strainer 12 and destroy the prime/vacuum of the pump that is drawing the water 30. The head assembly 10 therefore includes the optional baffle 28 mounted on the float 14. As shown in FIGS. 1, 3 and 4, the baffle 28 may be mounted on the float indirectly, by being mounted on the gusset member 24. Alternatively, the baffle 28 may be mounted directly on the strainer 12 or on the float 14. The baffle 28 extends along the upper surface of the strainer 12, optionally between the strainer 12 and the float 14. The head assembly 10 is configured so that when the float 14 is floating on the water 30, the baffle 28 is disposed below the water surface 30a, between the water surface and the upper part of the strainer 12. Preferably, the baffle 28 is a non-perforated structure. The baffle 28 is disposed at a distance from the strainer 12 to permit water to flow between the baffle and the strainer and to be drawn into the strainer 12 and the hose 20. The baffle 28 disrupts the formation of a vortex in the water between the strainer 12 and the water surface 30a. In this way, the baffle 28 helps prevent the introduction of air into the strainer 12 and helps maintain the prime/vacuum of the pump that is used to draw water via the head assembly 10.

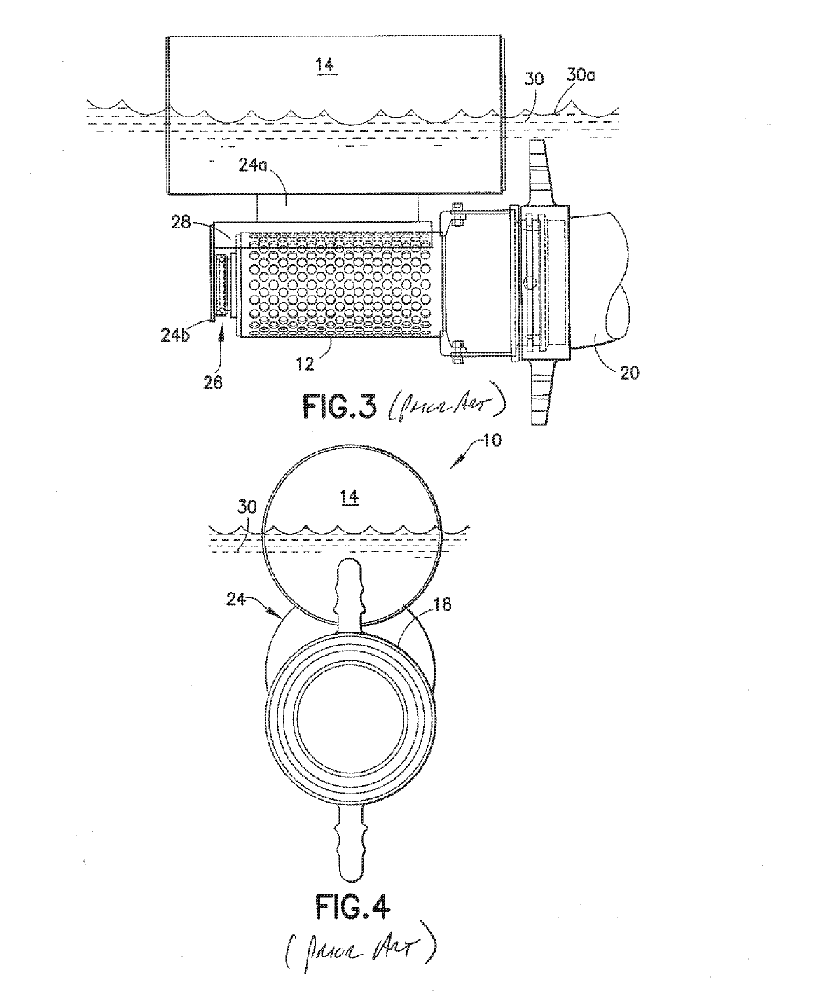

As seen in FIG. 1, the gusset member 24 has a flat, single plate configuration, and the baffle 28 is mounted on the gusset member. In an alternative arrangement illustrated in FIG. 3, a gusset member comprises two parts 24a and part 24b, and the baffle 28 is disposed between the parts 24a and 24b. The first part 24a of the gusset member connects the baffle 28 to the float 14, and the second part 24b of the gusset member is connected to the baffle 28 and provides a mounting point for the strainer 12.

In use, a hose 20 is attached to the head assembly 10 at the coupler 18, and the head assembly 10 is then placed in the body of water 30. When the strainer 12 has settled to its buoyant position under the surface 30a of the water 30, the pumping operation can begin. Water 30 is drawn into the hose 20 through the strainer 12 by force of at least a partial vacuum created by the pump (not shown). The strainer 12 prevents objects larger than the perforations 12a from entering the hose 20 and the stream of water being drawn into the hose 20. The baffle 28 prevents the formation of a vortex in the water 30 to at least substantially minimize or eliminate air from being drawn into the hose 20.

Another prior art suction head assembly is shown in FIG. 5 as a floating suction head assembly 50 comprised of a strainer 52 fixedly mounted on a float 14 via a gusset member 24. The strainer 52 has a coupling portion 56 where a coupler 58 is mounted for receiving the hose 20. The coupler 58 was mounted on the strainer 52 by a bearing (not shown). The bearing permitted the coupler 58 to rotate relative to the strainer 112 (around axis B) in response to torque received via a hose (not shown) connected to the coupler 58. However, it was found that placing the bearing (not shown) at the coupler 58 made the formation of a seal between a hose (not shown) on the coupler 58 and the strainer 52 difficult to attain and difficult to maintain. By placing the bearing instead at the other end of the strainer 52, surprisingly improved performance was achieved.

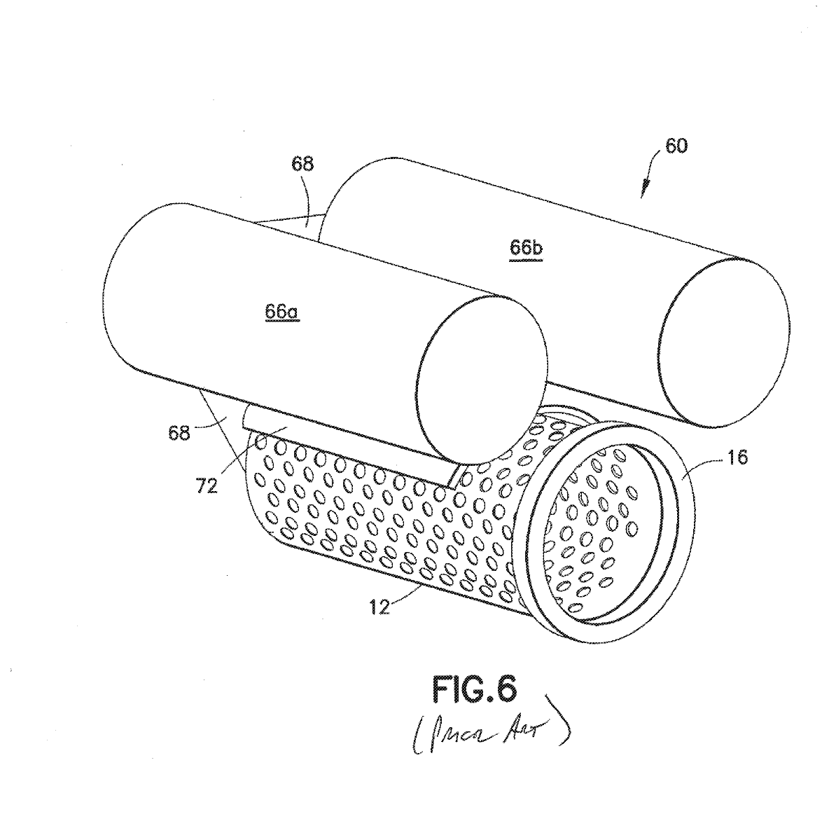

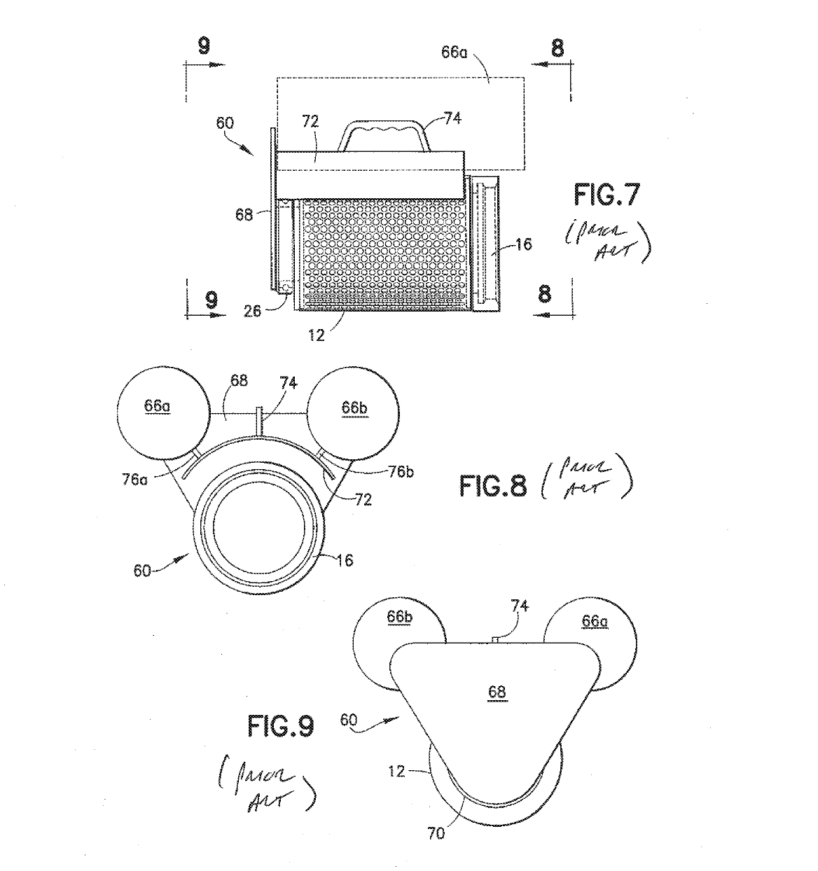

An alternative embodiment of the commonly owned, conventional floating suction head assembly of FIGS. 1 to 4, is shown in FIGS. 6 to 9. A commonly owned, conventional floating suction head assembly, designated by reference numeral 60 in FIG. 6 (hereinafter, the “head assembly 60”), comprises a strainer 12 secured to two buoyant floats 66a and 66b via a gusset member 68 on which the strainer 12 and the floats 66a and 66b are mounted. The strainer 12 is mounted on the gusset member 68 via a rotatable coupling that comprises a bearing 26 (FIG. 7), and the strainer 12 includes the coupling 16 for receiving a hose, e.g., the hose 20. The strainer 12 and the two floats 66a and 66b are mounted on the gusset member 68 in a triangular configuration as illustrated in FIG. 8. A baffle 72 is optionally mounted at one end on the gusset member 68 and extends about a surface of the strainer 12, e.g., a surface of the strainer 12 that faces upwardly and toward a space between the floats 66a and 66b. Two support plates 76a and 76b (FIG. 8) extend from the floats 66a and 66b to further support the baffle 72 on the head assembly 60. The clearance between the baffle 72 and the surface of the strainer 12 is sufficient to avoid creating significant resistance to the flow of water through the strainer 12 and into a hose attached to the head assembly 60. For example, a clearance of about 1.4 inch (e.g., 1.375 in.) is preferred for many purposes, although other clearances can be chosen to suit the intended use of the head assembly 60 by one of ordinary skill in the art, without undue experimentation. A carrying handle 74 is mounted on the baffle 72 of the assembly 60 for convenient portage and installation of the head assembly 60 at a point of operation or storage. The baffle 72 is otherwise configured similarly to the baffle 28 of the head assembly 10, and serves the same function as baffle 28.

When the head assembly 60 is placed in the body of water 30, the two floats 66a and 66b float at or about the top surface 30a of the water 30 on either side of the strainer 12, and the strainer 12 is submerged below and between the float 66a and 66b at a buoyant position under the top surface 30a of the water 30. Having the floats 66a and 66b on either side of the strainer 12 makes the head assembly 60 more stable in the water 30 than a suction head assembly having only a single float (such as the head assembly 10 (FIGS. 1 to 4)), so the head assembly 60 keeps the strainer 12 below the surface 30a of the water 30 even when the water 30 is subject to turbulence (waves) or when torque is transferred to the head assembly 60 via the hose 20 in circumstance in which a suction head assembly with just one float would allow the strainer to break the surface, or would allow a vortex to form and draw air into the hose. Accordingly, the head assembly 60 is perceived to perform more reliably than a suction head assembly with only one float.

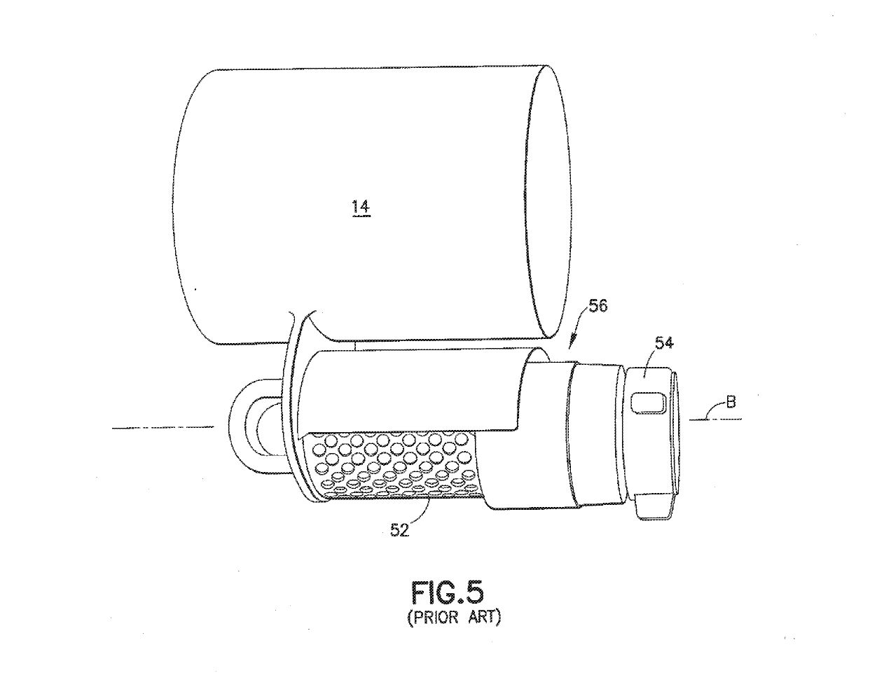

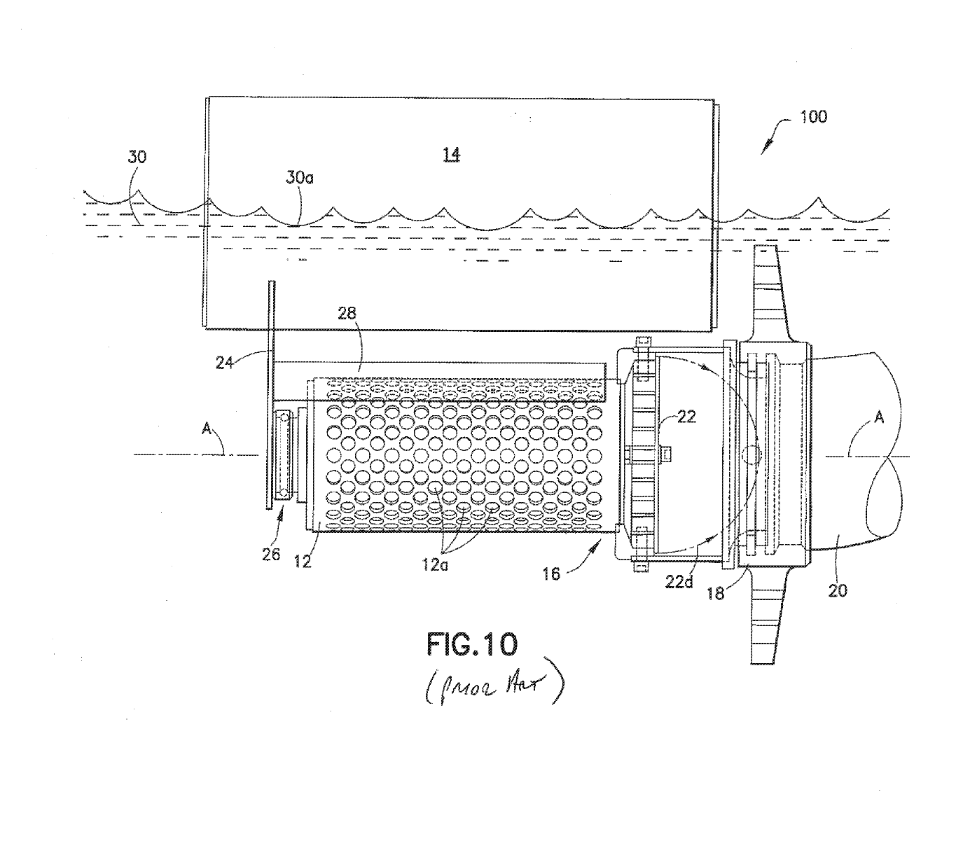

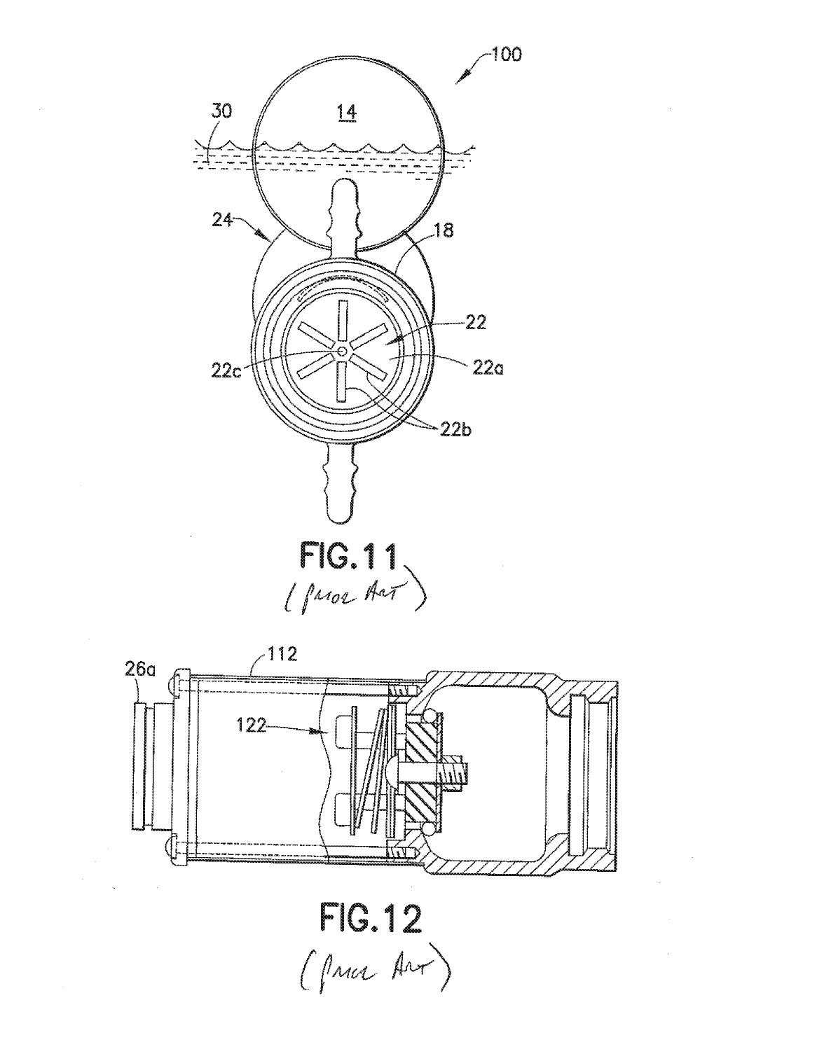

Another embodiment of a commonly owned, conventional floating suction head assembly, designated generally by reference numeral 100 in FIG. 10 (hereinafter the “head assembly”), includes an optional check valve 22 mounted in the coupler 18, but is otherwise similar to the head assembly 10 of FIGS. 1 to 4. Therefore, corresponding structures in head assemblies 10 and 100 bear like reference numerals, and the description of head assembly 10 conveys an understanding of the head assembly 100 with the following additional explanation concerning the check valve 22. The check valve 22 of the head assembly 100 is a collapsible diaphragm-type check valve, e.g., a valve that comprises a pliable disc that blocks an outlet of the strainer 12 to backflow from the hose 20, but which collapses to permit substantially un-obstructed flow of the stream of water from the strainer 12 into the hose 20. The check valve 22 is shown in FIG. 11 in a “closed” configuration, e.g., the check valve 22 is in position to inhibit backflow from the hose 20 into the strainer 12. The check valve 22 comprises a pliable disc 22a having a plurality of supporting ribs 22b thereon. The disc 22a is supported in the coupler 18 at a central point 22c on the disc. The supporting ribs 22b help open the disc 22a in response to backflow from the hose 10 and ensure that the disc obstructs the passage through the coupler 18 as shown in FIGS. 3 and 4, thus inhibiting the backflow from the hose 20 from entering the strainer 12. However, when a forward pressure differential develops across the check valve 22, the disc 22a collapses in an umbrella-like fashion (as indicated by arc 22d in FIG. 10) to permit flow from the strainer 12 into the hose 20.

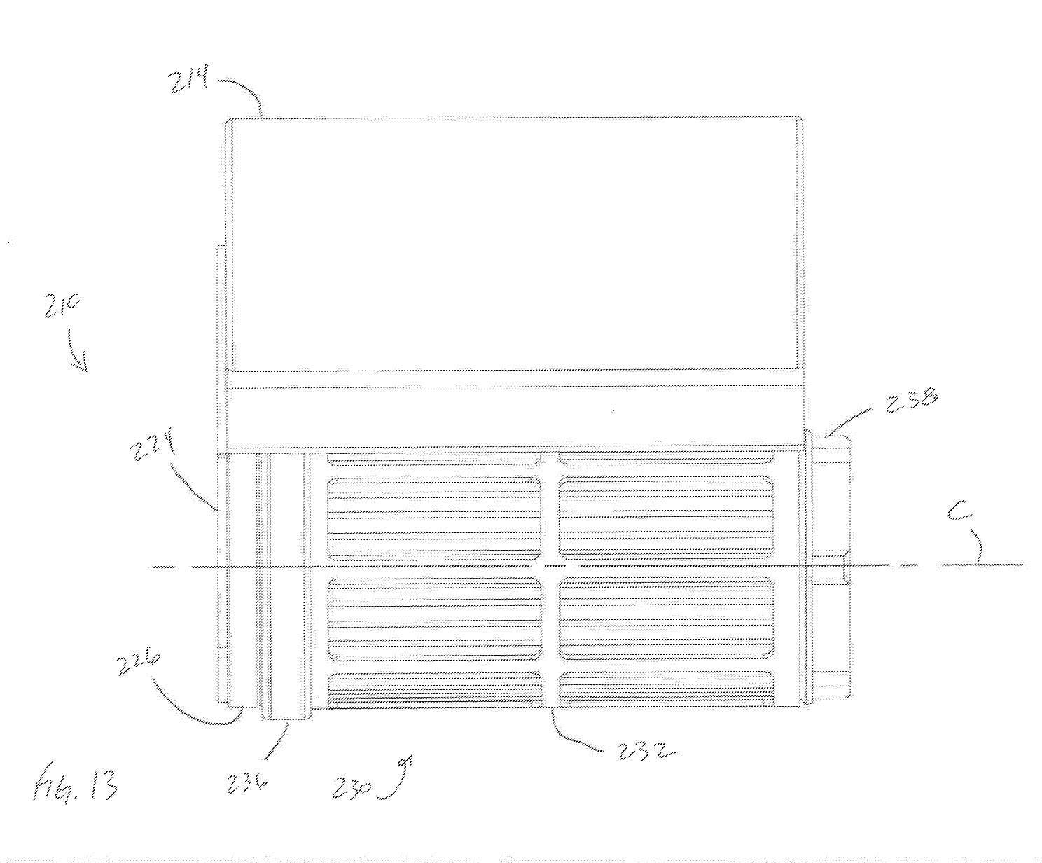

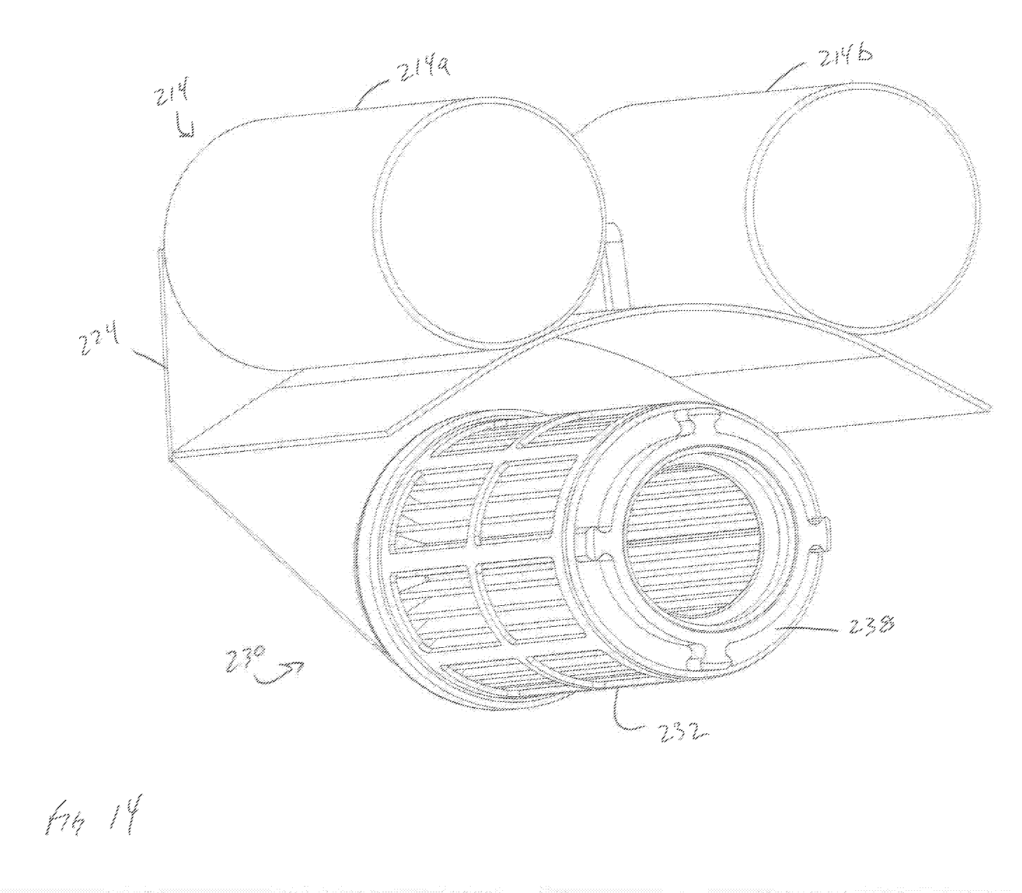

While the head assembly 100 includes a diaphragm-type check valve 22, in other embodiments of the conventional head assembly 100, other types of check valve may be employed, for example, a strainer 112 illustrated in FIG. 12 includes a poppet check valve 122. In still other embodiments, a strainer may include a disc check valve, a swing check valve, and the like. As shown in FIG. 12, the strainer 112 includes an inner race 26a thereon to illustrate that it may be used in assembly 10 or 100, as desired.

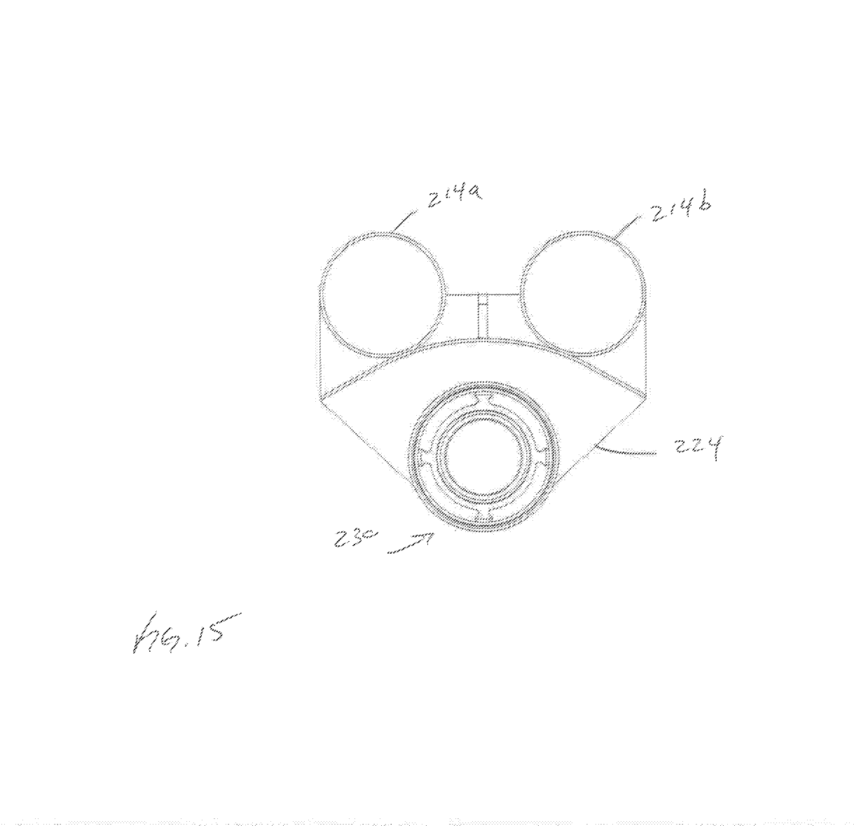

In accordance with one embodiment, as shown in FIGS. 13 to 18, an improved floating suction head assembly, generally designated by reference numeral 210 (hereinafter referred to also as the “head assembly 210”), comprises a strainer assembly 230 secured to a float assembly 214 by a gusset member 224 to which the strainer assembly 230 and the float assembly 214 are mounted. As shown in FIG. 13, the strainer assembly 230 is mounted to the gusset member 224 via a rotatable coupling portion 226. In one embodiment, the coupling portion 226 is comprised of a bearing, similar to the bearing 26, illustrated in an enlarged, detail view of FIG. 2. The coupling portion 226 permits the strainer assembly 230 to rotate relative to the gusset member 224 and to the float assembly 214 in response to torque received via a hose connected to the strainer assembly 230. The coupling portion 226 is aligned to permit the strainer assembly 230 to rotate about a central longitudinal axis C, described in detail below. As should be appreciated by those skilled in the art, in other embodiments, other rotatable coupling portions 226 may be comprised of a mounting pin, journal, bushing, or like means of rotation similar to the bearing 26.

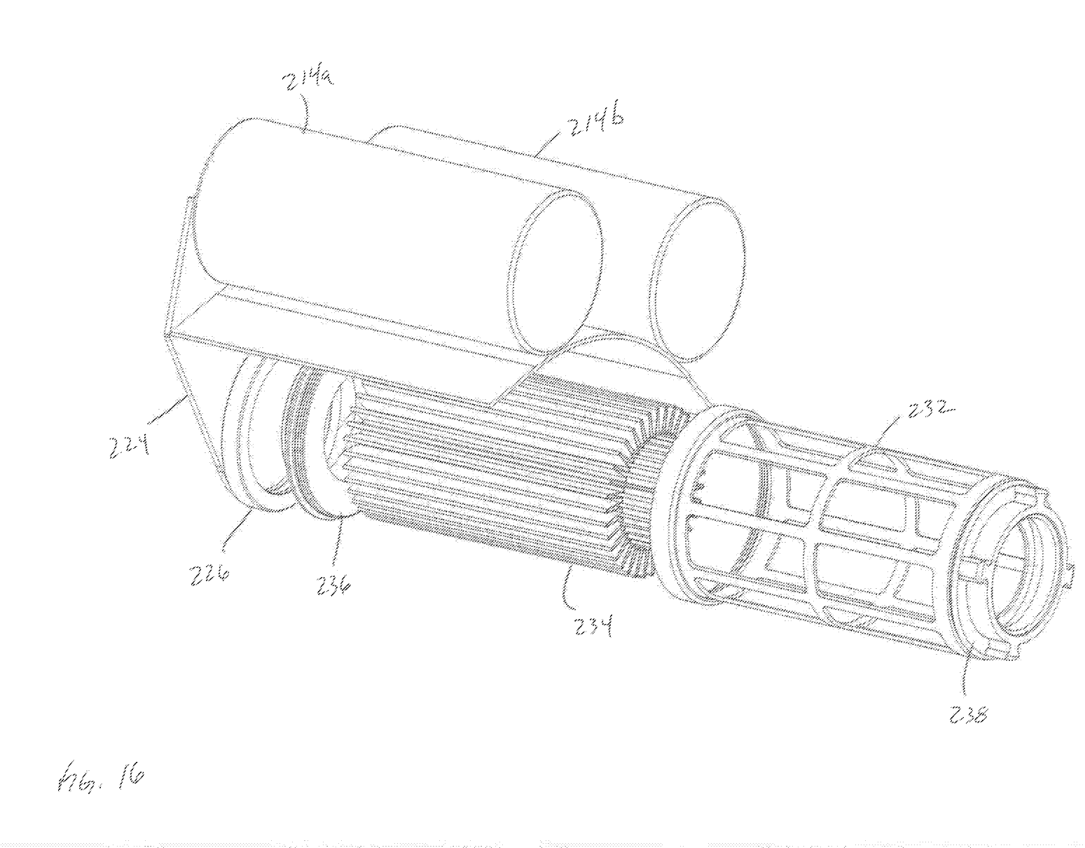

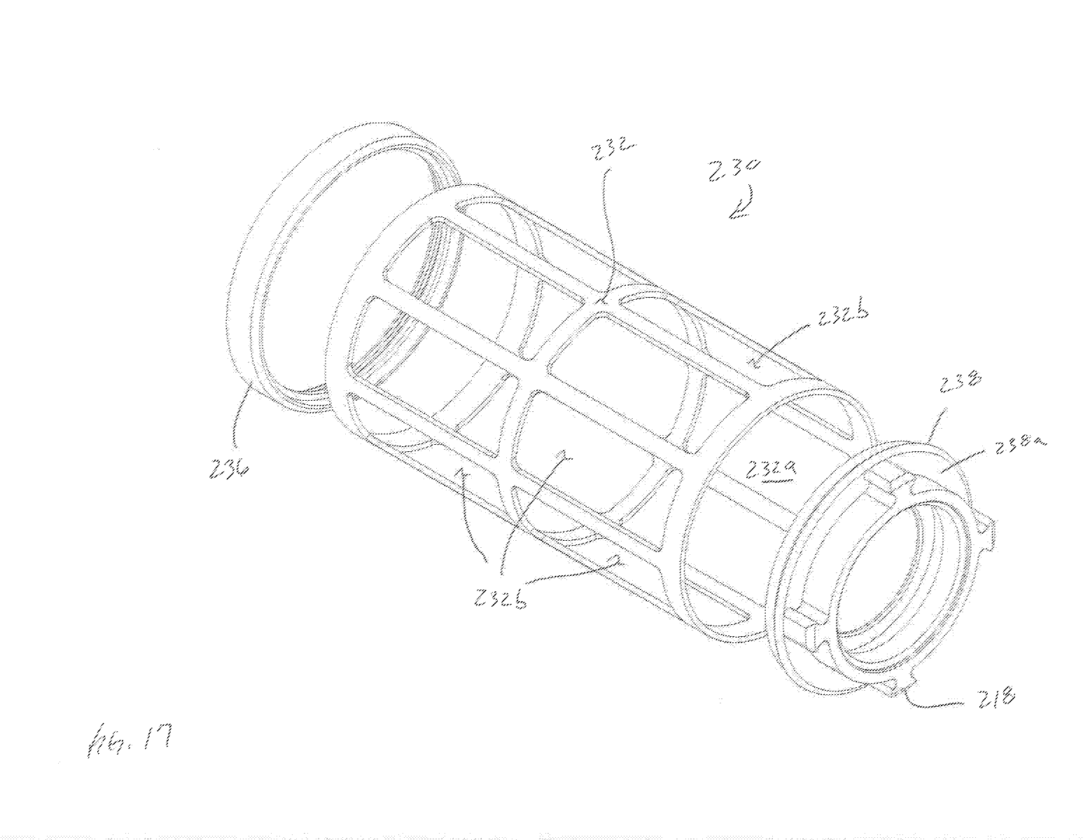

As should also be appreciated by those skilled in the art, the float assembly 214 is a buoyant body, for example, a hollow, rigid metal or plastic chamber, a solid buoyant material, or a pliable, inflatable floatation sac, or the like. As shown in FIGS. 14 and 15, in one embodiment, the float assembly 214 includes a plurality of buoyant bodies, for example, two floats 214a and 214b. The strainer assembly 230 includes non-buoyant components, described in detail below. The float assembly 214 is sufficiently buoyant that it floats when disposed in water 30 even with the strainer assembly 230 attached thereto and with a length of hose secured to the floating suction head assembly 210.

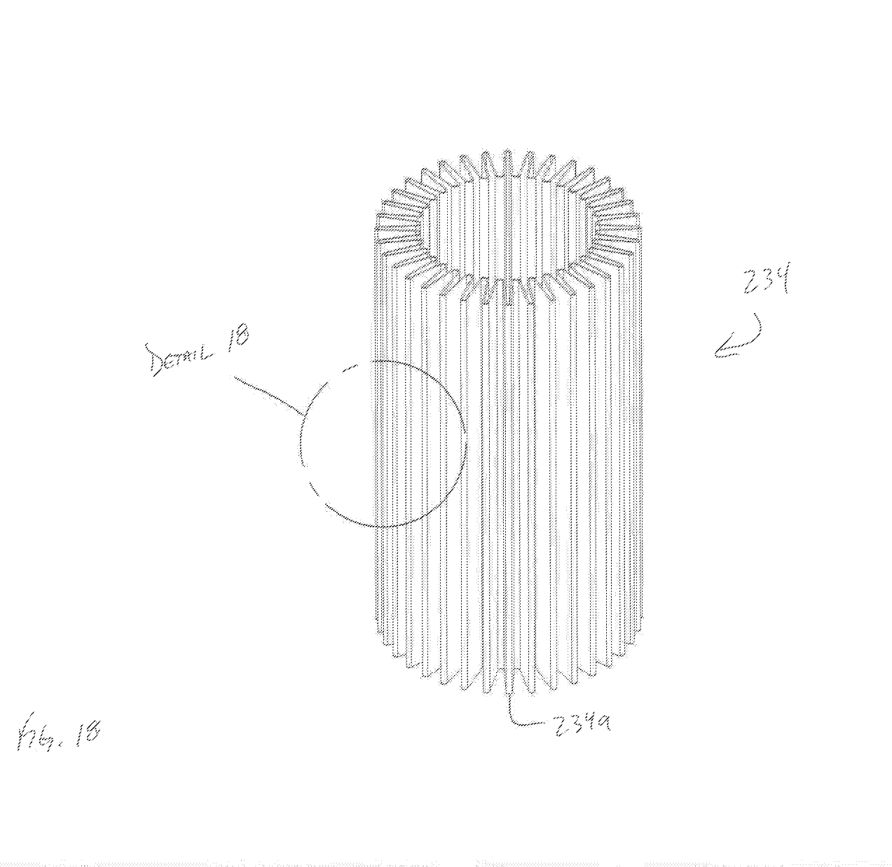

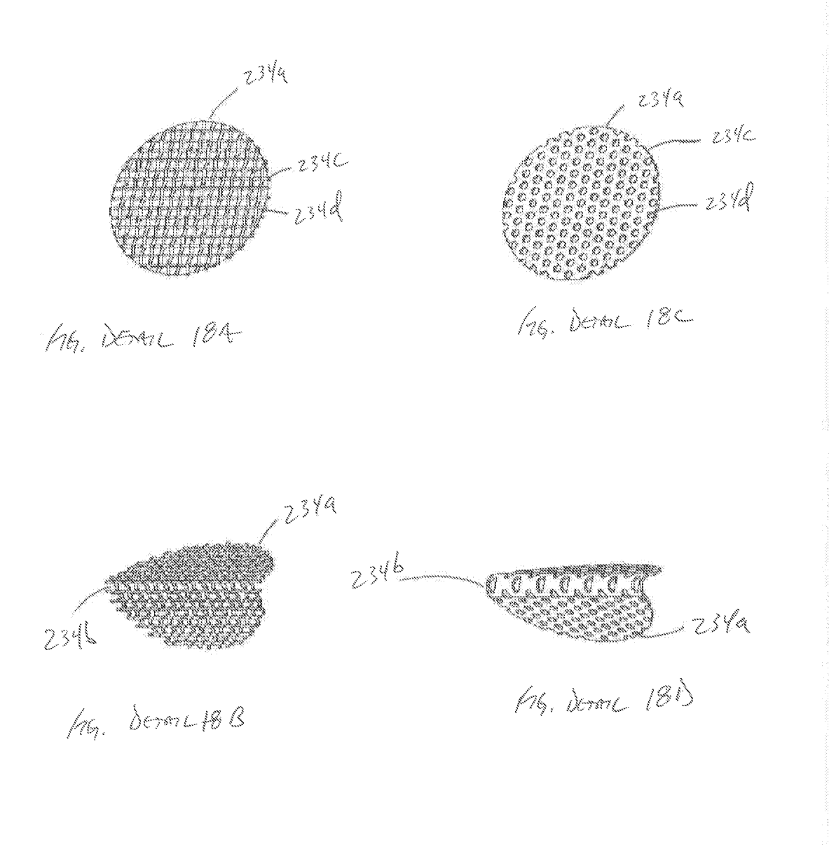

As shown in FIGS. 16 to 18, the strainer assembly 230 includes a strainer cage 232 defining an interior cavity 232a (FIG. 17) receiving and retaining a removable strainer cartridge 234 (FIG. 18) therein. The strainer cartridge 234 is removable for cleaning or other maintenance, or for replacement of the strainer cartridge with a new cartridge. In one embodiment, the strainer assembly 230 also includes a first end cap 236 and a second end cap 238 selectively couplable to the strainer cage 232 to facilitate retaining the strainer cartridge 234 therein. In one embodiment, the first end cap 236 and the second end cap 238 are coupled to the strainer cage 232 by threaded means. In one embodiment, the second end cap 238 includes a coupling portion 238a for receiving a hose, e.g., the hose 20. The coupling portion 238a is similar to the aforementioned coupling portion 16 and thus includes a coupler 218, similar to the coupler 18, for joining the hose to the strainer assembly 230. The coupler 218 optionally may be any standard hose coupler such as a Storz coupler, a NST coupler, a barb shank, etc., for a standard fire hose, a garden hose, and the like, of various diameters to accommodate an intended operation of the head assembly 10 and capacity (e.g., gallons per minute) of water intended to be drawn from the body of water in the pumping operation.

Referring again to FIG. 13, the strainer assembly 230 has a central, longitudinal axis C extending centrally through the strainer cage 232, the strainer cartridge 234, the first and the second end caps 236 and 238 and through the coupling portions 226 and 238a. As shown in FIGS. 16 to 18, when assembled, the strainer cage 232 and the strainer cartridge 234 have a generally cylindrical configuration to facilitate rotation about the central axis C. In one embodiment, the strainer cage 232 includes a plurality of openings or windows 232b disposed about a circumference of the strainer cage 232. In one embodiment, best illustrated in FIG. 17, the plurality of windows 232b are formed at predetermined locations about an entire circumference of the strainer cage 232.

As shown in FIG. 18, in one embodiment, the strainer cartridge 234 includes a corrugated exterior surface 234a including bent portions 234b forming alternating furrow and ridge portions substantially about the circumference of the strainer cartridge 234. In one embodiment, a configuration of the corrugated exterior surface 234a and of the strainer cartridge 234 itself, e.g., interior and exterior diameters, length, and the like, are designed to accommodate specific applications, e.g., minimum depth of a body of liquid from which liquid is to be drawn, a total surface area of the exterior surface 234a to facilitate use (pump capacity) at a predetermined rate of intake (e.g., more or less of a 350 gallon per minute intake), and the like. In one embodiment, the strainer cartridge 234 is comprised of a cylindrical member having a radius of about five and nine sixteenths inches (5.562 inches; 141.28 mm) to provide a total surface area of the exterior surface 234a of about four and one half square feet (4.5 ft²). It should be appreciated that the aforementioned dimensions of radius, length, surface area, and the like, are exemplary and not limiting, as it is in the scope of the present invention to vary the dimensions as is needed or desired for a particular use or application.

In various embodiments, illustrated in FIGS. Detail 18A to 18D, the strainer cartridge 234 is formed of wire mesh material or perforated sheet material having a plurality of solid surface portions 234c and perforated portions or perforations 234d. FIGS. Detail 18A to 18D illustrate the materials forming the corrugated exterior surface 234a of the strainer cartridge 234 in unbent (FIGS. Detail 18A and 18C) and bent (FIGS. 18B and 18D) configuration. In one embodiment, the perforated portions 234d do not exceed 0.094 in (2.38 mm) in width W (e.g., for wire mesh) and/or width or diameter D (e.g., for perforations in sheet material). As should be appreciated the total surface area of the exterior surface 234a will vary according to dimensions of the perforated portions 234d. It should be appreciated that while FIGS. 18C and 18D illustrate perforated sheet material with circular perforations 234d, it is within the scope of the present invention for the perforations 234d to be any configuration such as for example, oval, square, rectangular, and the like.

The terms “first,” “second,” and the like, herein do not denote any order, quantity, or importance, but rather are used to distinguish one element from another. In addition, the terms “a” and “an” herein do not denote a limitation of quantity, but rather denote the presence of at least one of the referenced item.

Although the invention has been described with reference to particular embodiments thereof, it will be understood by one of ordinary skill in the art, upon a reading and understanding of the foregoing disclosure, that numerous variations and alterations to the disclosed embodiments will fall within the spirit and scope of this invention and of the appended claims.

What is claimed is:

1. A floating suction head assembly comprising:
a float assembly;
a gusset member coupled to and extending from the float assembly;
a strainer assembly rotatably coupled to the gusset member at a first end of the strainer assembly, the strainer assembly extending outwardly from the gusset member in a longitudinal direction and being cantilevered relative thereto, the strainer assembly being rotatable relative to the gusset member and the float assembly about a central longitudinal axis defined by the strainer assembly, the strainer assembly including:
a strainer cage defining an interior cavity; and
a strainer cartridge selectively disposable in the interior cavity and retained therein, the strainer cartridge has a generally cylindrical configuration and rotates about the central longitudinal axis of the strainer assembly, the strainer cartridge includes a corrugated exterior surface including bent portions forming alternating furrow and ridge portions substantially about the circumference of the strainer cartridge; and
a coupling portion mounted on a second end of the strainer assembly opposite the first end, the coupling portion defining a bore extending therethrough, the bore being substantially coaxial with the central longitudinal axis, the coupling portion being adapted to matingly engage another coupling portion attached to an end of a hose.

2. The floating suction head assembly of claim 1, wherein the float assembly includes a plurality of buoyant bodies.

3. The floating suction head assembly of claim 1, wherein the strainer cartridge is formed of wire mesh material having a plurality of solid surface portions and perforated portions.

4. The floating suction head assembly of claim 3, wherein the perforated portions of the strainer cartridge do not exceed 0.094 in (2.38 mm) in width.

5. The floating suction head assembly of claim 1, wherein the strainer cartridge is formed of perforated sheet material having a plurality of solid surface portions and perforated portions.

6. The floating suction head assembly of claim 5, wherein the perforated portions of the strainer cartridge do not exceed 0.094 in (2.38 mm) in width or diameter.

7. The floating suction head assembly of claim 1, further comprising a baffle that extends partially around the strainer.
